(19) United States
(12) Patent Application Publication
(10) Pub. No.: US 2020/0382874 A1
(43) Pub. Date: Dec. 3, 2020

(54) SPEAKER

(71) Applicant: HOSIDEN CORPORATION, Osaka (JP)

(72) Inventors: Masahito FUKADA, Osaka (JP); Shunsuke KUROIWA, Osaka (JP); Yoshito FUJIMOTO, Osaka (JP); Atsushi NARA, Osaka (JP)

(21) Appl. No.: 16/883,061

(22) Filed: May 26, 2020

(30) Foreign Application Priority Data
May 27, 2019 (JP) 2019-098466

(51) Int. Cl. H04R 7/26; H04R 7/18

(52) U.S. Cl. CPC H04R 7/26; H04R 7/18

(57) ABSTRACT

A speaker includes a frame, a diaphragm supported by the frame, a rectangular tube-shaped coil that is wound into a rectangular shape and vibrates the diaphragm, and a pair of support dampers that support the coil and dampen vibrations of the coil. The pair of support dampers are arranged opposing each other across the coil. The support dampers each have a base portion that is supported by the frame and a support portion that supports the coil. The support portion has a first support portion that extends along and supports a surface of one side of the rectangular shape of the coil and a pair of second support portions that extend along and support surfaces of two sides respectively of the coil that are adjacent to the one side. The pair of second support portions extend from respective end portions of the first support portion.

### CROSS REFERENCE TO RELATED APPLICATIONS

This application is based on and claims priority under 35 U.S.C. Section 119 to Japanese Patent Application No. 2019-098466 filed on May 27, 2019, the entire content of which is incorporated herein by reference.

### TECHNICAL FIELD

This disclosure relates to a speaker.

### RELATED ART

JP2018-512014A discloses a speaker that converts an electrical audio signal into acoustic sound. This speaker includes a frame, a membrane (corresponding to a “diaphragm” of this disclosure), a rectangular coil affixed to the membrane, and a support member (corresponding to “support dampers” of this disclosure) supporting the coil. The support member includes a central loop portion, or a coil support portion, having a profile matching the profile of the coil, and a pair of lead supports extending outward from two ends respectively of one side of the loop portion of the rectangular coil. The central loop portion or the coil support portion is attached to the coil with an adhesive. The pair of lead supports are attached to the frame with an adhesive (see paragraphs 0036 and 0037 and FIG. 7, paragraph 0043 and FIG. 10, paragraph 0047 and FIG. 12, etc. of JP2018-512014A).

### SUMMARY

There is still room for improvement in speakers like that disclosed in JP2018-512014A, in terms of the joining strength between the coil and the support member, or adjustment of the properties of the support member (e.g., the mass of the support member) taking the sound characteristics of the speaker into account.

Embodiments of the present invention relate to a speaker with which the sound characteristics of the speaker can be adjusted while maintaining the joining strength between a coil and a support member.

A speaker of this disclosure includes a ring-shaped frame, a diaphragm supported by the frame, a rectangular tube-shaped coil that is wound into a rectangular shape, is arranged on an inner peripheral side of the frame, and vibrates the diaphragm, and a pair of support dampers that support the coil and dampen vibrations of the coil, wherein the pair of support dampers are arranged opposing each other across the coil, the support dampers each have a base portion that is supported by the frame and a support portion that supports the coil, the support portion has a first support portion that extends along and supports a surface of one side of the rectangular shape and a pair of second support portions that extend along and support surfaces of two sides respectively that are adjacent to the one side, and the pair of second support portions extend from respective end portions of the first support portion.

In this case, since the first support portion of the support portion of the support damper supports one side of the coil, and the second support portions thereof support portions of the two sides of the coil that are adjacent to the one side, the coil can be strongly and stably supported over time, compared with a case in which only one side of the coil is supported by the first support portion. Moreover, when the support portion supports the coil, the support portion needs to be supportably connected to the coil using a method such as adhesion, and this connection also can be made strong. For example, if the connection is realized using bonding through adhesion or the like, the area of the adherend can be increased by bonding the first support portion and the second support portions to the coil, compared with a case in which only the first support portion is bonded to the coil, and accordingly, the peel strength is improved. In this manner, with the above-described configuration, the joining strength between the coil and the support members can be enhanced, and the joining between the coil and the support members can be maintained and the coil and the support members can be kept joined to each other.

Moreover, in the above-described case, the support portions of the support dampers and the coil constitute an integrated vibration system (hereinafter referred to simply as the vibration system). Provided that the mass of the coil is constant, the mass of this vibration system can be adjusted by changing the size of the second support portions, such as the length or area of the second support portions extending along the surfaces of the above-described two sides. That is to say, with the above-described configuration, the mass of the vibration system can be adjusted by changing the size of the second support portions. For example, if the mass of the vibration system is increased, the sound pressure in the bass range of the speaker can be increased. In this manner, with the above-described configuration, the sound characteristics of the speaker can be adjusted by changing the size of the second support portions.

Moreover, in an embodiment of the speaker, a configuration can be employed in which the diaphragm is arranged opposing an upper surface of the coil, and the support portion supports a bottom surface of the coil.

In this case, the support portions of the support dampers support at least the bottom surface of the coil. The amplitude of vibrations of the coil in a thickness direction of the coil is regulated by the support portions. In the following description, the diaphragm side as seen from the coil is referred to as an upper side, and the opposite side is referred to as a lower side or a bottom side. For example, the bottom surface of the coil is the same as the lower surface of the coil. Moreover, for example, the support portions oppose the lower surface of coil.

Moreover, in an embodiment of the speaker, a configuration can be employed in which the support portion further has a peripheral support portion that supports either one of an outer peripheral surface and an inner peripheral surface of the tube of the coil.

In this case, the support portions of the support dampers support the bottom surface of the coil, and in addition to that, the peripheral support portions thereof support outer peripheral surfaces or inner peripheral surfaces of the tube of the coil. Thus, the coil is strongly supported by the support portions. Moreover, the connection strength between the coil and the support members can be enhanced.

Moreover, in an embodiment of the speaker, a configuration can be employed in which the base portion and the support portion are arranged in two parallel planes respectively when viewed in a direction perpendicular to an outer peripheral surface of the coil.

In this case, the positional relationship between the base portion and the support portion in the up-down direction can be set such that the base portion and the support portion are located at different positions. The amplitude of the coil can be adjusted by adjusting the positional relationship between the base portion and the support portion in the up-down direction.

Moreover, in an embodiment of the speaker, a configuration can be employed in which each of the pair of support dampers has a pair of beam portions that are each connected to the base portion at a first end and connected to the support portion at a second end, the second ends of the pair of beam portions are connected to the support portion at positions in an inner region of the first support portion in a longitudinal direction thereof, and the first ends of the pair of beam portions are connected to the base portion at positions outside the inner region of the first support portion in the longitudinal direction.

In this case, the direction from the second end toward the first end can be shifted from a direction orthogonal to the longitudinal direction of the first support portion to a direction extending outward in the longitudinal direction. Thus, even when the shortest distance (distance in a straight line) between the base portion and the first support portion is short, the length of each beam portion extending between the base portion and the first support portion can be increased. The increase in the length of the beam portions can allow for an increase in the amplitude of the coil.

Moreover, in an embodiment of the speaker, a configuration can be employed in which the beam portions are each formed into a crank shape.

In this case, the length of each beam portion can be increased by forming the beam portion into a crank shape. This can allow for an increase in the amplitude of the coil.

Moreover, in an embodiment of the speaker, a configuration can be employed in which the base portion is arranged so as to be parallel to the longitudinal direction of the first support portion, and extends over a region spanning from inside to outside the first support portion in at least the longitudinal direction, and the first ends of the pair of beam portions are connected to the base portion at positions located outward of the two ends of the first support portion in the longitudinal direction of the first support portion.

In this case, the first ends of the beam portions are connected to the base portion at positions located outward of the two ends of the first support portion in the longitudinal direction of the first support portion. Moreover, the second ends of the beam portions are connected to the support portion at positions located in the inner region of the first support portion in the longitudinal direction. Therefore, the length of each beam portion can be increased.

Moreover, in an embodiment of the speaker, a configuration can be employed in which an adhesive is arranged between the coil and the support portion, and the coil and the support portion are adhesively attached to each other with the adhesive, and a lead wire of the coil is led out from between the coil and the support portion.

In this case, the lead wire is a wire for energizing the coil, and is formed by extending an end portion of the wire itself of the coil. With the above-described configuration, at least a portion of the lead wire is embedded in a layer of the adhesive (between the coil and the support portion), and the lead wire is fixed between the coil and the support portion by the adhesive, so that the lead wire can be prevented from breaking due to vibrations or the like of the coil. Moreover, when a configuration is employed in which a base end portion of the lead wire is embedded in the layer of the adhesive, the base end portion is also reinforced by the adhesive. Thus, trouble, such as that where the base end portion of the lead wire breaks due to vibrations of the coil, can be prevented.

Moreover, in an embodiment of the speaker, a configuration can be employed in which, when the support portion is viewed in a direction from an upper surface toward a bottom surface of the coil, the support portion is formed by only a region surrounded by a single closed line.

In this case, when forming the support portion by punching a base material in a punching process, or forming the support portion by cutting out the support portion from a base material through laser cutting, no broken pieces (scraps and chips) independent of the support portion or a main portion of the remainder of the base material are created, and therefore the workability is excellent. Note that the region surrounded by a single closed line means that the shape of the region is a geometrical figure that can be drawn with only a single closed line. In other words, the periphery (outer periphery) of the support portion has a shape that can be drawn with a single stroke.

Moreover, in an embodiment of the speaker, a configuration can be employed in which two ends of the base portion in a longitudinal direction of the first support portion have respective cut-out portions each formed by cutting a portion in the base portion inward in the longitudinal direction, and the cut-out portions are engaged with the frame.

In this case, even when stress acting in a direction that intersects the longitudinal direction of the first support portion is applied to the support damper, the state in which the base portion is positioned in the intersecting direction can be maintained by the engagement between the frame and the cut-out portions extending along the longitudinal direction.

As described above, with the speaker of this disclosure, the sound characteristics of the speaker can be adjusted while maintaining the joining strength between a coil and a support member.

### BRIEF DESCRIPTION OF THE DRAWINGS

FIG. 1 is an exploded perspective view of a speaker.

FIG. 2 is a perspective view of the speaker when viewed from obliquely above.

FIG. 3 is a cross-sectional view of the speaker when viewed in the direction of arrows III-III.

FIG. 4 shows the speaker, with a bottom plate removed, when viewed from obliquely below.

FIG. 5 shows a support damper when viewed from above.

FIG. 6 is a cross-sectional view of a first support portion when viewed in the direction of arrows VI-VI.

FIG. 7 is a cross-sectional view of a second support portion when viewed in the direction of arrows VII-VII.

FIG. 8 is an explanatory diagram illustrating a reinforced state of a branch portion where a lead branches off from a coil.

FIG. 9 is a schematic diagram illustrating another manner in which the support damper is attached.

FIG. 10 shows a support damper according to another embodiment when viewed from above.

FIG. 11 shows a support damper according to yet another embodiment when viewed from above.

FIG. 12 shows a speaker according to another embodiment when viewed from obliquely below, with a bottom plate removed.

### DESCRIPTION OF EMBODIMENTS

A speaker according to an embodiment of this disclosure will be described based on the drawings.

### Overall Configuration

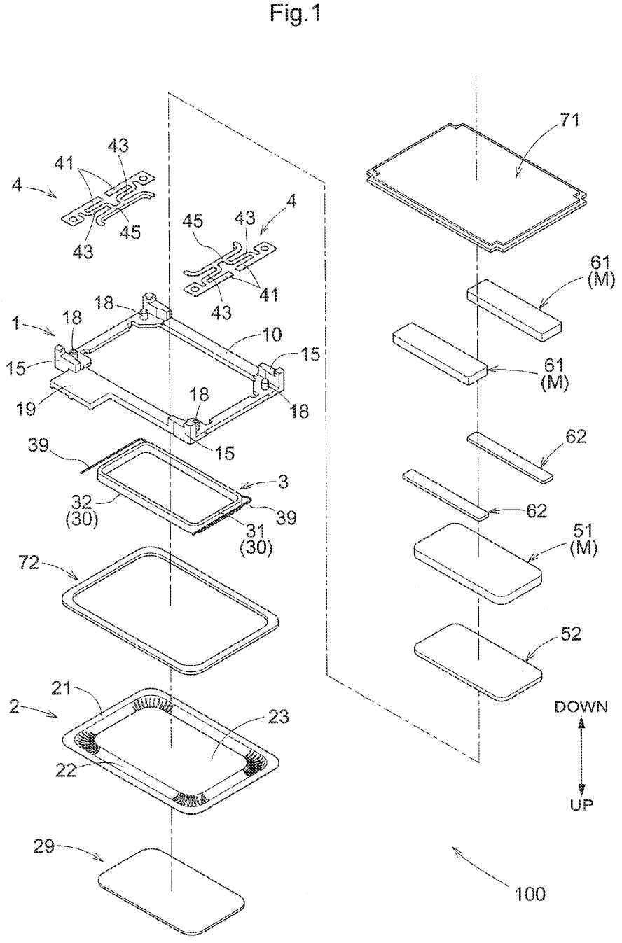

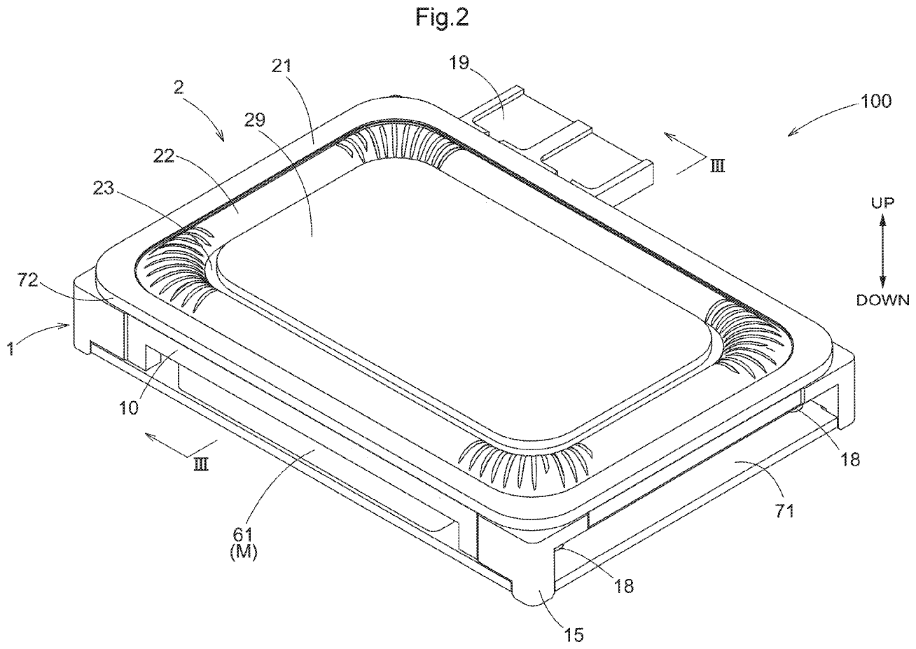

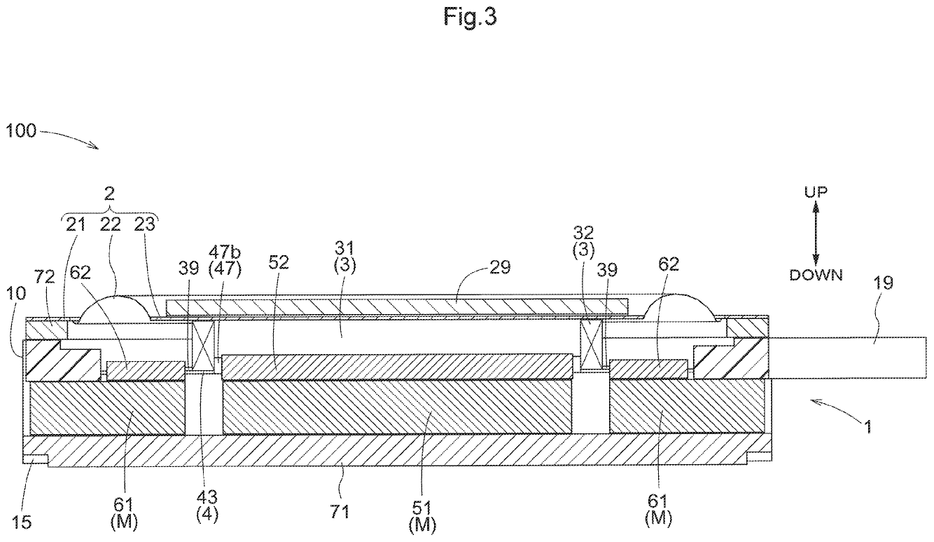

FIG. 1 shows an exploded perspective view of a speaker 100 according to the present embodiment. FIG. 2 shows a perspective view of the speaker 100. FIG. 3 is a cross-sectional view of the speaker 100. As shown in FIG. 1, the speaker 100 includes a rectangular frame 1 that supports various portions of the speaker 100; a diaphragm 2 supported by the frame 1; a rectangular coil 3 arranged on an inner peripheral side of the frame 1 while being in contact with one face of the diaphragm 2; a pair of support dampers 4, each support damper 4 having a base portion 41 supported by the frame 1 and a support portion 45 that extends along a side of the coil 3 and supports the coil 3; and a magnet M that exerts a magnetic force on the coil 3. In the following description, the diaphragm 2 side as seen from the coil 3 is defined as an upper side and the opposite side as a lower side, and a direction in which the coil 3 and the diaphragm 2 are stacked is referred to as an up-down direction (see FIGS. 1 to 3).

### Configurations of Various Portions

The frame 1 is a frame body made of a resin, such as a polyphthalamide resin, or a metal material. As shown in FIGS. 1 and 2, the frame 1 has a rectangular ring-shaped plate-like frame portion 10, four column portions 15 extending downward from an outer peripheral portion of the ring of the frame portion 10 at respective end portions of two long sides of the frame portion 10, and four column-shaped bosses 18 extending downward from a lower surface (surface located on the lower side in the up-down direction) of the frame portion 10 at the four corners of the frame portion 10. In the present embodiment, an external terminal 19 of the speaker 100 is formed on the outer peripheral portion of the frame 1.

A bottom plate 71 is mounted to lower ends of the four column portions 15. The bottom plate 71 is formed of a magnetic material (magnetic body) made of metal, such as a cold rolled steel sheet. As shown in FIG. 3, the diaphragm 2, the coil 3, the support dampers 4, the magnet M, and the like are accommodated in a space surrounded by the frame 1 and the bottom plate 71.

The bosses 18 are cylindrical members having a circular cross-sectional shape in a direction intersecting the direction in which the columns extend. The base portions 41 of the support dampers 4 are fixed to the four bosses 18 as will be described later.

The diaphragm 2 is a thin plate-like member that transfers vibrations generated in the speaker 100 to air, and thereby emits sound waves. As shown in FIGS. 1 and 2, the diaphragm 2 has a rectangular, outer peripheral frame portion 21; a rectangular, movable support portion 22 that is arranged on an inner peripheral side of the outer peripheral frame portion 21 and has a curved surface shape that protrudes upward, for example; and a vibration surface portion 23 that is a rectangular plate surface arranged on an inner peripheral side of the movable support portion 22.

As shown in FIGS. 1 and 3, the diaphragm 2 is placed on a rectangular support frame 72 that is placed on the frame portion 10 of the frame 1. The support frame 72 is formed of a non-magnetic material (non-magnetic body) made of metal such as stainless steel. A lower surface of the outer peripheral frame portion 21 and an upper surface (surface that is located on the upper side in the up-down direction) of the support frame 72 are adhesively attached to each other using an adhesive, for example. A lower surface of the support frame 72 and an upper surface of the frame portion 10 are adhesively attached to each other using an adhesive, for example.

The vibration surface portion 23 transmits vibration energy generated by the coil 3, which will be described later, to air and thereby emits sound waves. A rectangular plate-like baffle 29 for stabilizing the vibration state of the diaphragm 2 is placed on an upper surface of the vibration surface portion 23. The baffle 29 is a member for making sound quality adjustments, such as the adjustment of the mass of the vibration surface of the diaphragm 2 and the vibration damping thereof.

As shown in FIGS. 1 and 3, the coil 3 is a member obtained by winding a wire into a rectangular ring (rectangular tube shape), and serves as a magnetic field generating mechanism that generates a magnetic field corresponding to the direction and magnitude of an electric current. Due to the interaction between a magnetic field generated by the coil 3 and a magnetic field generated by the magnet M, which will be described later, the coil 3 converts electrical energy passing therethrough into vibration energy, thereby vibrating itself with an amplitude in the up-down direction. The vibrations of the coil 3 cause the vibration surface portion 23 to vibrate.

The coil 3 has a ring portion 30 (see FIG. 1), which is a rectangular ring portion, and a pair of leads 39 (an example of lead wires). The axial direction (thickness direction) of the ring of the ring portion 30 is set to extend along the up-down direction. Note that, in the present embodiment, the axis of the ring of the ring portion 30 coincides with the center of gravity of the ring of the ring portion 30. An upper surface of the ring portion 30 is adhesively attached to a lower surface of the vibration surface portion 23 using an adhesive or the like. The vibration energy generated by the coil 3 is transferred to the vibration surface portion 23 and converted into sound waves.

In the present embodiment, the leads 39 extend from a lower surface of the ring portion 30 at corner portions of the ring portion 30. The leads 39 are end portions of the wound wire (wire) itself, which constitutes the coil 3. As will be described later, the support portions 45 are bonded to base end portions 39a (see FIG. 8) of the leads 39, the base end portions 39a being boundary portions where the leads 39 separate from the ring portion 30, so as to cover the base end portions 39a.

In the following description, sides of the rectangular ring portion 30 that constitute the short sides are defined as short side portions 31, and portions of the rectangular ring portion 30 that constitute the long sides are defined as long side portions 32 (see FIG. 1). That is to say, sides that are adjacent to each single short side portion 31 are the long side portions 32. Moreover, a direction that is the same as the direction extending along the short side portions 31 is defined as a depth direction, and a direction that is the same as this depth direction may be referred to simply as the depth direction. Furthermore, a direction that is the same as the direction extending along the long side portions 32 is defined as a width direction, and a direction that is the same as this width direction may be referred to simply as the width direction.

The magnet M is a permanent magnet such as a ferrite magnet. The magnet M exerts a magnetic field on the coil 3. In the present embodiment, the magnet M includes a rectangular plate-like first magnet 51 that is arranged in a region inside the ring portion 30 in the radial direction of the ring portion 30 of the coil 3, and a pair of rectangular plate-like second magnets 61 that are arranged in regions outside the ring portion 30. As shown in FIG. 3, the first magnet 51 and the second magnets 61 are arranged at positions below the ring portion 30 in the up-down direction. Moreover, the first magnet 51 and the second magnets 61 are placed on an upper surface of the bottom plate 71. In the present embodiment, the first magnet 51 and the second magnets 61 are fixed to the upper surface of the bottom plate 71 using an adhesive or the like.

The first magnet 51 and the second magnets 61 are arranged in such orientations that plate surfaces of the magnets intersect (e.g., are orthogonal to) the up-down direction. The directions of magnetic fields generated by the first magnet 51 and the second magnets 61 are set to be opposite from each other. For example, if the magnetic pole on an upper surface of the first magnet 51 is the N-pole, the magnetic poles on upper surfaces of the second magnets 61 are the S-poles. In this case, the magnetic field generated by the first magnet 51 flows from the upper surface thereof to the upper surfaces of the second magnets 61 through the outer periphery of the wire bundle of the ring of the ring portion 30. In the present embodiment, the second magnets 61 are arranged with the long axes thereof extending in the direction along the long side portions 32.

A rectangular plate-like first pole piece 52 is placed on the upper surface of the first magnet 51. The first pole piece 52 is arranged with its longitudinal direction extending along the longitudinal direction of the first magnet 51. The cross-sectional shape of the first pole piece 52 in a plane (hereinafter referred to as the horizontal plane) that intersects the up-down direction is a rectangle that is the same as the cross-sectional shape of the first magnet 51 in a horizontal plane. The first pole piece 52 is arranged in a region inside the ring portion 30 in the radial direction of the ring portion 30. The first pole piece 52 is arranged spaced apart inward from an inner peripheral surface of the ring portion 30. The first pole piece 52 is arranged so as to partially overlap the ring portion 30 when viewed in the radial direction of the ring portion 30. An upper surface of the first pole piece 52 is arranged so as to be located between the upper surface and the lower surface of the ring portion 30 in the up-down direction. The first pole piece 52 is formed of a magnetic material (magnetic body). The first pole piece 52 converges the magnetic field generated by the first magnet 51 to the ring portion 30.

Rectangular plate-like second pole pieces 62 are placed on upper surfaces of the respective second magnets 61. The second pole pieces 62 are arranged with their longitudinal directions extending along the longitudinal directions of the second magnets 61. In other words, the second pole pieces 62 are arranged with their longitudinal directions extending along the long side portions 32. The second pole pieces 62 are arranged spaced apart outward from an outer peripheral surface of the ring portion 30. The second pole pieces 62 are arranged so as to overlap the second magnets 61 when viewed in the up-down direction. Outer peripheries of the second pole pieces 62 are located in regions inside the outer peripheries of the respective second magnets 61 when viewed in the up-down direction. The second pole pieces 62 are arranged so as to partially overlap the long side portions 32 (ring portion 30) when viewed in the radial direction of the ring portion 30. Upper faces of the second pole pieces 62 are arranged so as to be located between the upper surface and the lower surface of the ring portion 30 in the up-down direction. The second pole pieces 62 are formed of a magnetic material (magnetic body). The second pole pieces 62 converge the magnetic fields generated by the second magnets 61 to the ring portion 30.

That is to say, the magnetic fields respectively generated from upper ends of the first magnet 51 and the second magnets 61 are converged by the first pole piece 52 and the second pole pieces 62, respectively, and flow through the ring portion 30. Thus, even when the electric current flowing through the coil 3 is small, a large electromagnetic force can be exerted on the coil 3 to generate large vibrations, and the speaker 100 can hence emit a large sound with a small electric current.

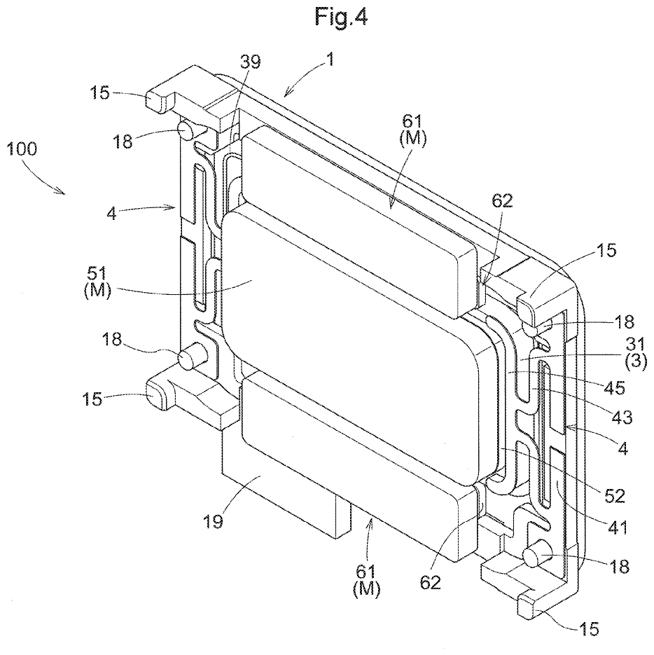

FIG. 4 shows a perspective view of the speaker 100, with the bottom plate 71 removed, when viewed from obliquely below. As shown in FIG. 4, the support dampers 4 are members via which the coil 3 is supported by the frame 1, and also serve as a vibration damping mechanism that absorbs vibrations of the coil 3. The support dampers 4 are, for example, each formed as a single member (in the form of a single thin plate) by being cut from a thin plate such as a polymer film (e.g., a thin plate having a thickness of about 0.1 to 0.2 mm or a film-like material) made of multilayer polyimide or the like, through a punching process or using a laser. The support dampers 4 are used as a pair, and the coil 3 is supported by the frame 1 via the pair of support dampers 4. The support dampers 4 are arranged opposing each other across the ring portion 30 of the coil 3, and in the present embodiment, the support dampers 4 are arranged so as to mainly support the short side portions 31 of the coil 3.

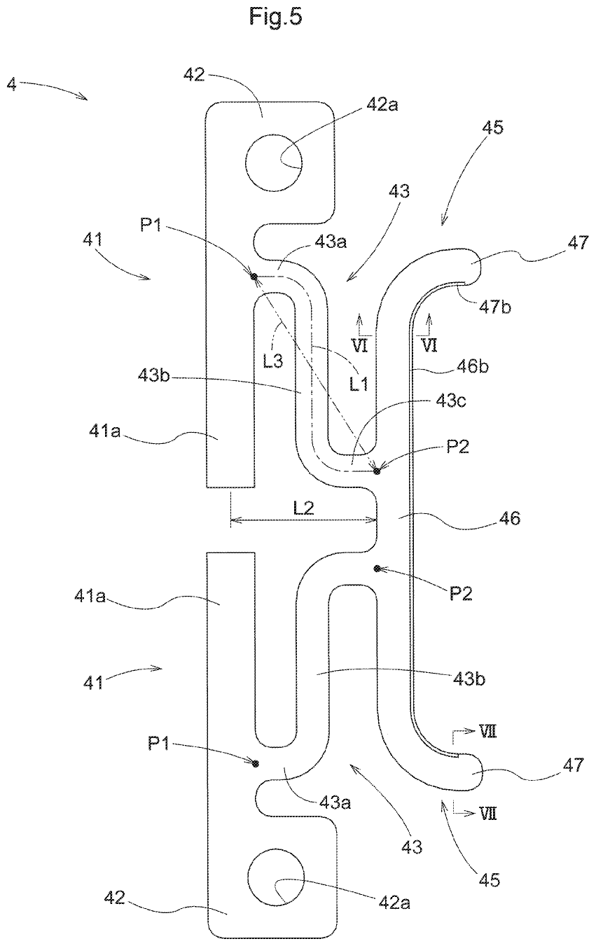

As shown in FIGS. 4 and 5, each support damper 4 has the base portion 41 that is supported by the frame 1 (see FIG. 4), the support portion 45 that supports the coil 3, and a pair of beam portions 43 via which the support portion 45 is supported by the base portion 41. The base portion 41, the beam portions 43, and the support portion 45 are arranged so as to overlap when viewed in the width direction. That is to say, the base portion 41, the beam portions 43, and the support portion 45 lie in the same plane.

As shown in FIG. 5, the base portion 41 is a root portion of the support damper 4 that is to be adhesively attached and fixed to the frame 1. Although the base portion 41 may be formed as a single piece, the base portion 41 of the present embodiment is constituted by a pair of base portion pieces 41a. The base portion pieces 41a are arranged such that the longitudinal directions of rectangular main body portions thereof extend along the depth direction, and, in the present embodiment, the longitudinal directions of the base portion pieces 41a are parallel to the depth direction. The pair of base portion pieces 41a are arranged such that the main body portions thereof are aligned in a straight line in their longitudinal directions, and the direction in which the base portion 41 extends is parallel to the depth direction. Two end portions of the base portion 41 in the depth direction are provided with fixing seats 42 in which through holes 42a penetrating the thin plate surfaces thereof are formed.

The base portion 41 is mounted to a lower surface of the frame 1 while being positioned thereon with the bosses 18 (see FIG. 4) being inserted into (engaged with) the respective through holes 42a. Moreover, since the bosses 18 are engaged with the through holes 42a, even when tensile stress acting in the width direction is applied to the support damper 4 due to vibrations of the coil 3, the state in which the base portion 41 is positioned in the width direction can be maintained. In the present embodiment, the base portion 41 is fixed by bonding an upper surface of the base portion 41 to the lower surface of the frame 1 using an adhesive or the like.

The support portion 45 is a member that is fixed to the coil 3 (see FIG. 4) by being joined thereto through adhesion or the like, and allows the coil 3 to be supported by the frame 1 as the support damper 4. The support portion 45 has a first support portion 46 that extends along a corresponding one of the short side portions 31 and supports the ring portion 30 (see FIG. 4), as well as a pair of second support portions 47 that extend from two end portions respectively of the first support portion 46 along the respective long side portions 32. In the present embodiment, the first support portion 46 is a portion of the support portion 45 that extends in a straight line-shape, and includes no bent portions. The second support portions 47 include portions that are curved from the two ends of the first support portion 46 in conformity with the shape of the ring portion 30 of the coil 3.

The first support portion 46 extends along a surface of the short side portion 31 (see FIG. 4) of the coil 3 over the entire length of the short side portion 31 in the extending direction thereof, and is bonded to the short side portion 31 using an adhesive or the like. Since the first support portion 46 extends along the surface of the short side portion 31, the first support portion 46 extends in the depth direction. The two ends of the first support portion 46 in the depth direction are located inward, in the depth direction, of the two ends of the base portion 41 in the depth direction.

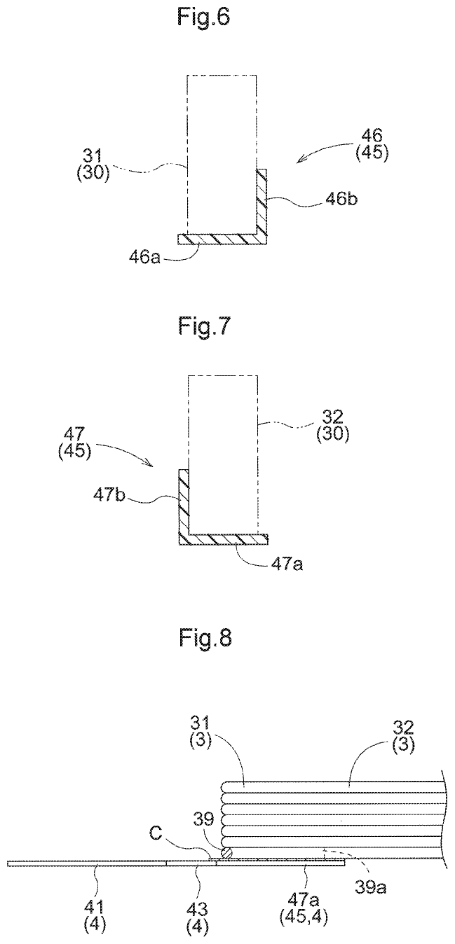

As shown in FIG. 6, the first support portion 46 includes a first bottom support portion 46a that is bonded to a lower surface (bottom surface) of the short side portion 31 of the coil 3 (see FIG. 4), and a first peripheral support portion 46b that is bonded to an inner peripheral surface of the short side portion 31. The first bottom support portion 46a supports the short side portion 31 at its lower surface. The first peripheral support portion 46b supports the short side portion 31 at its inner peripheral surface. The first peripheral support portion 46b is bonded to the inner peripheral surface of the short side portion 31 in the following manner: after the first bottom support portion 46a of the first support portion 46 has been bonded to the lower surface (bottom surface) of the short side portion 31, a portion of the first support portion 46 that is located inside the ring portion 30 is further bent upward. The adhesion or fixation of the first support portion 46 to the short side portion 31 can be made strong by adhesively attaching the first bottom support portion 46a and the first peripheral support portion 46b of the first support portion 46 to the short side portion 31.

As shown in FIG. 5, the second support portions 47 extend from the two ends of the first support portion 46 in the depth direction, and extend along and are bonded to surfaces of the long side portions 32, respectively, over partial lengths of the long side portions 32 in their extending direction (width direction) with use of an adhesive or the like. Extending end portions of the second support portions 47 are spaced apart from the extending end portions of the second support portions 47 of the other (opposing) support damper 4.

As shown in FIG. 7, each second support portion 47 includes a second bottom support portion 47a that is bonded to a lower surface (bottom surface) of a corresponding one of the long side portions 32, and a second peripheral support portion 47b that is bonded to an inner peripheral surface of the long side portion 32. The second bottom support portion 47a supports the long side portion 32 at its lower surface. The second peripheral support portion 47b supports the long side portion 32 at its inner peripheral surface.

The second peripheral support portion 47b is bonded to the inner peripheral surface of the long side portion 32 in the following manner: after the second bottom support portion 47a of the second support portion 47 has been bonded to the lower surface (bottom surface) of the long side portion 32, a portion of the second support portion 47 that is located inside the ring portion 30 is further bent upward. The adhesion or fixation of the second support portion 47 to the long side portion 32 can be made strong by adhesively attaching the second bottom support portion 47a and the second peripheral support portion 47b of the second support portion 47 to the long side portion 32.

An adjustment to increase or reduce the total weight of the coil 3 (see FIG. 3) and the support portions 45 can be made by increasing or reducing the lengths of the second support portions 47 in the width direction. It is possible to adjust the natural frequency of the coil 3 and the support portions 45, and thereby adjust the sound characteristics of the speaker 100, by adjusting the total weight of the coil 3 and the support portions 45.

As described above, as shown in FIG. 8, each support portion 45 is bonded to a corresponding one of the base end portions 39a, which are the boundary portions where the respective leads 39 separate from the ring portion 30, so as to cover the base end portion 39a. In the present embodiment, for example, the base end portion 39a is arranged between the second bottom support portion 47a and the long side portion 32 and embedded in a layer of an adhesive C with which the second bottom support portion 47a is bonded to the long side portion 32. The base end portion 39a is thus reinforced by the adhesive, so that trouble, such as that where the base end portion 39a is broken due to vibrations of the coil 3, for example, can be prevented.

As shown in FIG. 5, each beam portion 43 is continuous with (connected to) a corresponding one of the base portion pieces 41a (base portion 41), which is adhesively attached and fixed to the frame 1, at one end P1, and is continuous with (connected to) the first support portion 46 at another end P2. Each beam portion 43 resiliently supports the support portion 45, with the end P1 serving as a fixed end and the end P2 serving as a free end, and thereby absorbs vibrations of the coil 3 supported by the support damper 4.

The beam portions 43 of the present embodiment are each formed into a crank shape, and each include a rectangular first side 43a that is continuous with the base portion piece 41a, a rectangular third side 43c that is continuous with the first support portion 46, and a rectangular second side 43b that is continuous with the first side 43a and the third side 43c. The first side 43a extends from the base portion piece 41a toward a side that is closer to the coil 3 in at least the width direction. The third side 43c extends from the first support portion 46 toward a side that is away from the coil 3 in at least the width direction. In the present embodiment, the second side 43b extends in a direction that is parallel to the depth direction.

The ends P1 (end portions of the first sides 43a on the base portion piece 41a side) of the beam portions 43 are connected to the respective base portion pieces 41a at positions on the base portion 41 that are located outward of the two ends of the first support portion 46 in the depth direction. The ends P2 (end portions of the third sides 43c on the first support portion 46 side) of the beam portions 43 are connected to an inner region of the first support portion 46 in the depth direction, that is, a central portion of the first support portion 46 excluding the two end portions of the first support portion 46 in the depth direction. Thus, the distance L1 on each beam portion 43 from the end P1 to the end P2 of the beam portion 43 can be sufficiently longer than the shortest distance L2 from the base portion 41 to the first support portion 46 in the width direction. Therefore, the amplitude of the coil 3 in the up-down direction can be increased. This makes it possible to adjust the sound characteristics of the speaker 100.

Note that, in the present embodiment, the distance L1 that is longer than the distance L3 from the end P1 to the end P2 in the case where the beam portion 43 extends in a straight line is obtained by forming each beam portion 43 into a crank shape.

In the above-described manner, it is possible to provide a speaker with which the sound characteristics of the speaker can be adjusted while maintaining the joining strength between a coil and a support member.

### Other Embodiments

(1) In the foregoing embodiment, regarding the support portions 45, a case has been described in which each support portion 45 has the first support portion 46 that extends along the short side portion 31 and supports the ring portion 30, and the pair of second support portions 47 that extend from the two end portions respectively of the first support portion 46 along the respective long side portions 32. Moreover, regarding the first support portion 46, a case has been described in which the first support portion 46 includes the first bottom support portion 46a that is bonded to the lower surface of the short side portion 31. Also, regarding the second support portions 47, a case has been described in which the second support portions 47 include the second bottom support portions 47a that are bonded to the lower surfaces of the respective long side portions 32. Furthermore, it has been described that the first bottom support portion 46a supports the short side portion 31 at its lower surface, and the second bottom support portions 47a support the respective long side portions 32 at their lower surfaces. However, the manner in which the support portion 45 supports the ring portion 30 is not limited to the example described above. In the present embodiment, it is sufficient that the support portion 45 supports at least portions of the long side portions 32, in addition to the short side portion 31.

For example, the support portion 45 may support the short side portion 31 and the long side portions 32 from upper surfaces thereof, instead of the first bottom support portion 46a and the second bottom support portions 47a supporting these portions. In this case, the support portion 45 can be bonded to the upper surfaces of the short side portion 31 and the long side portions 32.

(2) In the foregoing embodiment, regarding the support portions 45, a case has been described in which each support portion 45 has the first support portion 46 that extends along the short side portion 31 and supports the ring portion 30, and the pair of second support portions 47 that extend from the two end portions respectively of the first support portion 46 along the respective long side portions 32. Moreover, regarding the first support portion 46, a case has been described in which the first support portion 46 includes the first bottom support portion 46a that is bonded to the lower surface of the short side portion 31, and the first peripheral support portion 46b that is bonded to the inner peripheral surface of the short side portion 31. Also, regarding the second support portions 47, a case has been described in which the second support portions 47 include the second bottom support portions 47a that are bonded to the lower surfaces of the respective long side portions 32, and the second peripheral support portions 47b that are bonded to the inner peripheral surfaces of the respective long side portions 32. Furthermore, it has been described that the first peripheral support portion 46b supports the short side portion 31 at its inner peripheral surface, and the second peripheral support portions 47b supports the long side portions 32 at their inner peripheral surfaces. However, the configuration of the support portion 45 is not limited to the above-described configuration.

For example, the support portion 45 may support outer peripheral surfaces of the ring portion 30, instead of the first peripheral support portion 46b and the second peripheral support portions 47b supporting the inner peripheral surfaces of the ring portion 30. In this case, the first peripheral support portion 46b and the second peripheral support portions 47b can be bonded to outer peripheral surfaces of the short side portion 31 and the long side portions 32.

Moreover, one or both of the first peripheral support portion 46b and the second peripheral support portions 47b may be omitted from the support portion 45.

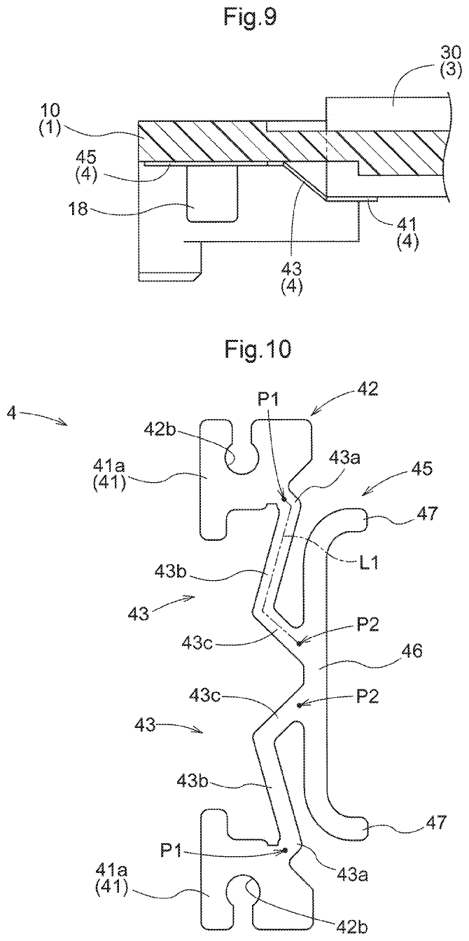

(3) In the foregoing embodiment, regarding the support dampers 4, a case has been described in which each support damper 4 has the base portion 41 and the support portion 45, and the base portion 41 and the support portion 45 are arranged overlapping each other when viewed in the width direction, but the configuration of the support portion 45 is not limited to this. The base portion 41 and the support portion 45 may also be arranged in two parallel planes respectively when viewed in a direction that is perpendicular to an outer peripheral surface of the ring portion 30 (e.g., when viewed in the width direction or the depth direction). That is to say, the base portion 41 and the support portion 45 may be arranged at different positions in the up-down direction. FIG. 9 schematically shows the support damper 4 and surrounding portions when viewed in the depth direction, in the case in which the base portion 41 and the support portion 45 are arranged in two parallel planes respectively, and the base portion 41 is located at a position below the support portion 45 in the up-down direction. The amplitude of the coil 3 can be adjusted by changing the positional relationship between the base portion 41 and the support portion 45 in the up-down direction in this manner.

(4) In the foregoing embodiment, regarding the ends P1 of the beam portions 43, a case has been described in which the ends P1 are continuous with the respective base portion pieces 41a at positions on the base portion 41 that are located outward of the two ends of the first support portion 46 in the depth direction. However, the ends P1 of the beam portions 43 may be continuous with the respective base portion pieces 41a at positions located inward of the two ends of the first support portion 46 and outward of connecting portions where the ends P2 are connected to the first support portion 46, in the depth direction.

(5) In the foregoing embodiment, regarding the beam portions 43, a case has been described in which the beam portions 43 are each formed into a crank shape. However, the beam portions 43 may each extend in a straight line from the end P1 to the end P2, or may each extend in a curved line having one or more curved portions.

(6) In the foregoing embodiment, regarding the beam portions 43, a case has been described in which the beam portions 43 are each formed into a crank shape and each include the rectangular first side 43a that is continuous with the corresponding base portion piece 41a, the rectangular third side 43c that is continuous with the first support portion 46, and the rectangular second side 43b that is continuous with the first side 43a and the third side 43c, and the second side 43b extends in a direction that is parallel to the depth direction. However, the crank shape of the beam portions 43 is not limited to that described above. As shown in FIG. 10, each beam portion 43 may be formed such that the second side 43b extends in such a direction that the distance from the first support portion 46 gradually increases from the first side 43a toward the third side 43c. In this manner, the distance L1 can be made even longer.

(7) In the foregoing embodiment, a case has been described by way of example in which the two end portions of the base portion 41 in the depth direction are provided with the fixing seats 42 in which the through holes 42a penetrating the thin plate surfaces thereof are formed, and the base portion 41 is mounted to the lower surface of the frame 1 while being positioned thereon with the bosses 18 inserted into the respective through holes 42a. However, the method for positioning the base portion 41 on the lower surface of the frame 1 is not limited to a case in which protruding portions such as the bosses 18 of the frame 1 are passed through (engaged with) the through holes 42a penetrating the thin plate surfaces of the base portion 41.

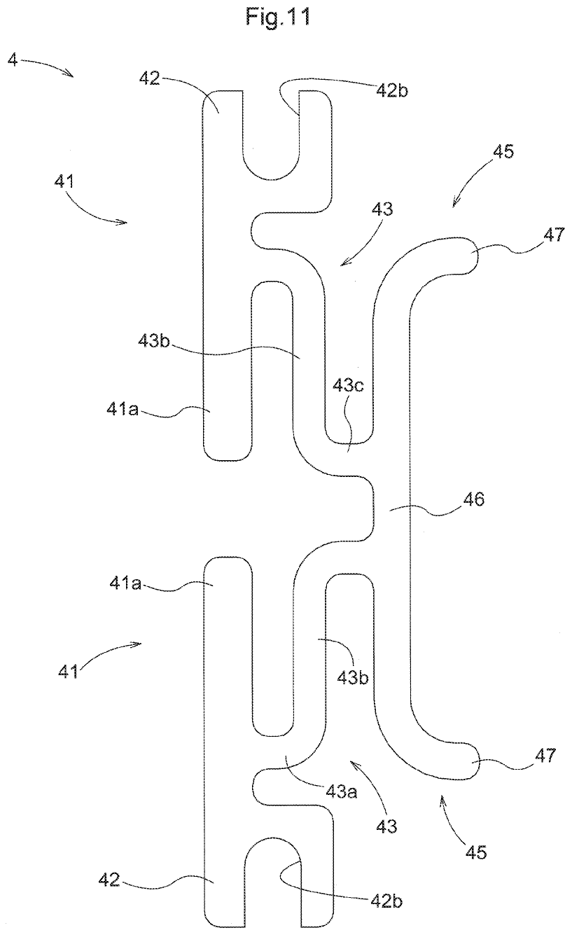

For example, as shown in FIGS. 10 and 11, instead of the through holes 42a penetrating the thin plate surfaces of the base portion 41, the two end portions of the base portion 41 in the depth direction may be provided with cut-out portions 42b formed by cutting out a portion in each of the two end portions inward in the depth direction. In this case, protruding portions such as the bosses 18 (see FIG. 4) of the frame 1 can be fitted into (engaged with) the cut-out portions 42b. In this case as well, even when tensile stress acting in the width direction is applied to the support damper 4 due to vibrations of the coil 3, the state in which the base portion 41 is positioned in the width direction can be maintained by the engagement of the bosses 18 with the cut-out portions 42b that extend along the depth direction.

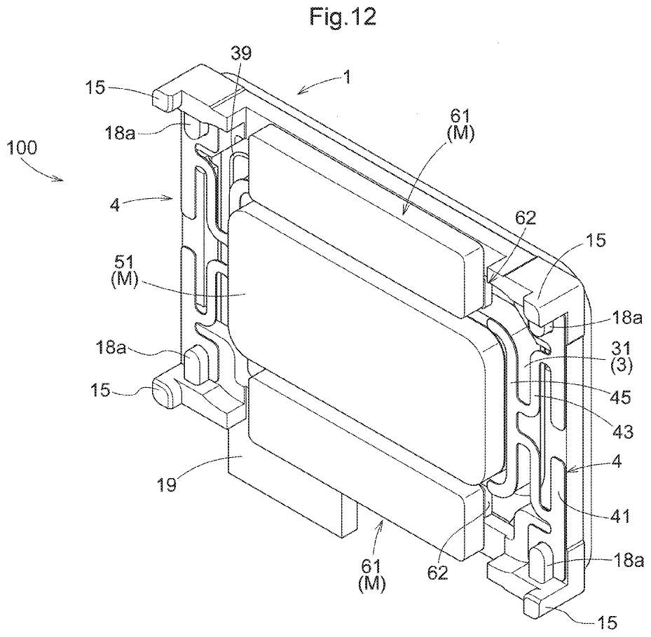

In the case where the cut-out portions 42b that are recessed inward in the depth direction are provided instead of the through holes 42a, in addition to this, the bosses 18 of the frame 1 may also be replaced by ribs 18a as shown in FIG. 12. That is to say, it is also possible to reinforce the structural strength of the frame 1 by providing the ribs 18a extending in the depth direction from inner wall surfaces of the column portions 15 of the frame 1 in the depth direction, and to engage the ribs 18a with the cut-out portions 42b (see FIG. 11) by inserting (fitting) the ribs 18a therein. In this case as well, even when tensile stress acting in the width direction is applied to the support damper 4 due to vibrations of the coil 3, the state in which the base portion 41 is positioned in the width direction can be maintained by the engagement of the ribs 18a with the cut-out portions 42b.

Note that, as shown in FIGS. 10 and 11, in the case where the cut-out portions 42b are provided instead of the through holes 42a, each support damper 4 can be formed by only a region surrounded by a single closed line when the support damper 4 is viewed from above. In this case, when forming the support damper 4 by punching a base material in a punching process, or forming the support damper 4 by cutting out the support member from a base material through laser cutting, no broken pieces (scraps and chips) independent of the support damper 4 or a main portion of the remainder of the base material are created, and therefore the workability is excellent. For example, if a broken piece adheres to the support damper 4 that has been formed, it is necessary to remove the broken piece through air-blowing or the like, and accordingly this may hinder continuous production (cause a reduction in throughput). However, if no broken pieces are created, the step of removing a broken piece is no longer necessary, and therefore, the throughput of continuous production improves.

Note that a configuration disclosed in one of the foregoing embodiments (including the other embodiments, the same shall apply hereinafter) can be used in combination with a configuration of any other embodiments as long as there is no contradiction. Moreover, the embodiments disclosed herein should be considered as illustrative and not limiting embodiments of this disclosure, and appropriate modifications can be made thereto without departing from the object of this disclosure.

This disclosure is applicable to a speaker.

1. A speaker comprising:
a ring-shaped frame;
a diaphragm supported by the frame;
a rectangular tube-shaped coil that is wound into a rectangular shape, is arranged on an inner peripheral side of the frame, and vibrates the diaphragm; and
a pair of support dampers that support the coil and dampen vibrations of the coil,
wherein the pair of support dampers are arranged opposing each other across the coil,
the support dampers each have a base portion that is supported by the frame and a support portion that supports the coil,
the support portion has a first support portion that extends along and supports a surface of one side of the rectangular shape and a pair of second support portions that extend along and support surfaces of two sides respectively that are adjacent to the one side, and
the pair of second support portions extend from respective end portions of the first support portion.

2. The speaker according to claim 1,
wherein the diaphragm is arranged opposing an upper surface of the coil, and
the support portion supports a bottom surface of the coil.

3. The speaker according to claim 2,
wherein the support portion further has a peripheral support portion that supports either one of an outer peripheral surface and an inner peripheral surface of the tube of the coil.

4. The speaker according to claim 2,
wherein the base portion and the support portion are arranged in two parallel planes respectively when viewed in a direction perpendicular to an outer peripheral surface of the coil.

5. The speaker according to claim 3,
wherein the base portion and the support portion are arranged in two parallel planes respectively when viewed in a direction perpendicular to an outer peripheral surface of the coil.

6. The speaker according to claim 1,
wherein each of the pair of support dampers has a pair of beam portions that are each connected to the base portion at a first end and connected to the support portion at a second end,
the second ends of the pair of beam portions are connected to the support portion at positions in an inner region of the first support portion in a longitudinal direction thereof, and
the first ends of the pair of beam portions are connected to the base portion at positions outside the inner region of the first support portion in the longitudinal direction.

7. The speaker according to claim 2,
wherein each of the pair of support dampers has a pair of beam portions that are each connected to the base portion at a first end and connected to the support portion at a second end,
the second ends of the pair of beam portions are connected to the support portion at positions in an inner region of the first support portion in a longitudinal direction thereof, and
the first ends of the pair of beam portions are connected to the base portion at positions outside the inner region of the first support portion in the longitudinal direction.

8. The speaker according to claim 3,
wherein each of the pair of support dampers has a pair of beam portions that are each connected to the base portion at a first end and connected to the support portion at a second end,
the second ends of the pair of beam portions are connected to the support portion at positions in an inner region of the first support portion in a longitudinal direction thereof, and
the first ends of the pair of beam portions are connected to the base portion at positions outside the inner region of the first support portion in the longitudinal direction.

9. The speaker according to claim 4,
wherein each of the pair of support dampers has a pair of beam portions that are each connected to the base portion at a first end and connected to the support portion at a second end,
the second ends of the pair of beam portions are connected to the support portion at positions in an inner region of the first support portion in a longitudinal direction thereof, and
the first ends of the pair of beam portions are connected to the base portion at positions outside the inner region of the first support portion in the longitudinal direction.

10. The speaker according to claim 5,
wherein each of the pair of support dampers has a pair of beam portions that are each connected to the base portion at a first end and connected to the support portion at a second end,
the second ends of the pair of beam portions are connected to the support portion at positions in an inner region of the first support portion in a longitudinal direction thereof, and
the first ends of the pair of beam portions are connected to the base portion at positions outside the inner region of the first support portion in the longitudinal direction.

11. The speaker according to claim 6,
wherein the beam portions are each formed into a crank shape.

12. The speaker according to claim 7,
wherein the beam portions are each formed into a crank shape.

13. The speaker according to claim 8,
wherein the beam portions are each formed into a crank shape.

14. The speaker according to claim 9,
wherein the beam portions are each formed into a crank shape.

15. The speaker according to claim 10,
wherein the beam portions are each formed into a crank shape.

16. The speaker according to claim 6,
wherein the base portion is arranged so as to be parallel to the longitudinal direction of the first support portion, and extends over a region spanning from inside to outside the first support portion in at least the longitudinal direction, and
the first ends of the pair of beam portions are connected to the base portion at positions located outward of the two ends of the first support portion in the longitudinal direction of the first support portion.

17. The speaker according to claim 7,
wherein the base portion is arranged so as to be parallel to the longitudinal direction of the first support portion, and extends over a region spanning from inside to outside the first support portion in at least the longitudinal direction, and
the first ends of the pair of beam portions are connected to the base portion at positions located outward of the two ends of the first support portion in the longitudinal direction of the first support portion.

18. The speaker according to claim 1,
wherein an adhesive is arranged between the coil and the support portion, and the coil and the support portion are adhesively attached to each other with the adhesive, and
a lead wire of the coil is led out from between the coil and the support portion.

19. The speaker according to claim 1,
wherein, when the support portion is viewed in a direction from an upper surface toward a bottom surface of the coil, the support portion is formed by only a region surrounded by a single closed line.

20. The speaker according to claim 1,
wherein two ends of the base portion in a longitudinal direction of the first support portion have respective cut-out portions each formed by cutting out a portion in the base portion inward in the longitudinal direction, and the cut-out portions are engaged with the frame.
